(19) United States
(12) Patent Application Publication
(10) Pub. No.: US 2025/0234351 A1
(43) Pub. Date: Jul. 17, 2025

(54) CONFIGURED UPLINK GRANT FOR SMALL DATA TRANSMISSION

(71) Applicant: Lenovo (Singapore) Pte. Ltd., New Tech Park (SG)

(72) Inventors: Joachim Löhr, Wiesbaden (DE); Prateek Basu Mallick, Dreieich (DE); Alexander Golitschek Edler von Elbwart, Darmstadt (DE); Hyung-Nam Choi, Ottobrun (DE); Ravi Kuchibhotla, Chicago, IL (US)

(21) Appl. No.: 18/703,262

(22) PCT Filed: Dec. 7, 2022
(86) PCT No.: PCT/IB2022/061908

§ 371 Date: Apr. 19, 2024

Related U.S. Application Data
(60) Provisional application No. 63/287,033, filed on Dec. 7, 2021.

(51) Int. Cl. H04W 72/21; H04L 1/1812; H04W 72/115; H04W 72/1263; H04W 76/27

(52) U.S. Cl. CPC H04W 72/21; H04L 1/1812; H04W 72/115; H04W 72/1263; H04W 76/27

(57) ABSTRACT

Apparatuses, methods, and systems are disclosed for small data transmission (SDT) procedure using configured grant (CG) resources. One method includes transmitting, to the network entity, an initial configured grant small data transmission of a SDT procedure using a configured uplink grant for small data transmission. The method includes suppressing the processing of subsequent configured uplink grants allocated for small data transmission for an initial new transmission of subsequent uplink data of the SDT procedure. The method includes receiving confirmation of the initial configured grant small data transmission. The method includes processing a subsequent configured uplink grant allocated for small data transmission for the initial new transmission of subsequent uplink data of the SDT procedure in response to receiving the confirmation of the initial configured grant small data transmission.

### CROSS-REFERENCE TO RELATED APPLICATIONS

This application claims priority to U.S. Provisional Patent Application No. 63/287,033 entitled “CG-SDT PROCEDURE FOR SMALL DATA TRANSMISSIONS IN RRC_INACTIVE” and filed on 7 Dec. 2021 for Joachim Löhr, Prateek Basu Mallick, Alexander Golitschek, Hyung-Nam Choi, and Ravi Kuchibhotla, which application is incorporated herein by reference.

### FIELD

The subject matter disclosed herein relates generally to wireless communications and more particularly relates to configuring a User Equipment (“UE”) with uplink resources, e.g., a Configured Grant (“CG”), for Small Data Transmission (“SDT”).

### BACKGROUND

Third Generation Partnership Project (“3GPP”) New Radio (“NR”) systems support RRC_INACTIVE state and devices with infrequent (periodic and/or non-periodic) data transmission are generally maintained by the network in the RRC_INACTIVE state. However, according to current 3GPP standards the RRC_INACTIVE state does not support transmission of data. Therefore, a User Equipment (“UE”) has to resume the connection (i.e., move to RRC CONNECTED state) to transmit any uplink (i.e., Mobile-Originating) data or to receive any downlink (i.e., Mobile-Terminated) data.

### BRIEF SUMMARY

Disclosed are procedures related to SDT procedure using CG resources. Said procedures may be implemented by apparatus, systems, methods, or computer program products.

One method at a UE includes receiving, from a network entity, a configuration that allocates configured uplink grants for small data transmission and transmitting, to the network entity, an initial configured grant small data transmission of a SDT procedure using a configured uplink grant for small data transmission. The method includes suppressing processing a subsequent configured uplink grant allocated for small data transmission for an initial new transmission of subsequent uplink data of the SDT procedure and receiving, from the network entity, confirmation of the initial configured grant small data transmission. The method includes processing a subsequent configured uplink grant allocated for small data transmission for the initial new transmission of subsequent uplink data of the SDT procedure in response to receiving the confirmation of the initial configured grant small data transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for SDT procedure using CG resources;

FIG. 2 is a block diagram illustrating one embodiment of a New Radio (“NR”) protocol stack;

FIG. 3 is a diagram illustrating one embodiment of a Radio Resource Control (“RRC”) Resume procedure;

FIG. 4A is a diagram illustrating one embodiment of a procedure for Random Access Channel and/or Configured Grant (“RACH/CG”)-based SDT procedure in RRC_INACTIVE;

FIG. 4B is a diagram illustrating one embodiment of a procedure for Random Access Channel (“RACH”)-based SDT procedure with subsequent data transmissions;

FIG. 5 is a flow diagram illustrating one embodiment of a procedure for the selection of SDT or non-SDT resources;

FIG. 6 is a diagram illustrating one embodiment of Abstract Syntax Notation 1 (“ASN.1”) form for a LogicalChannelConfig Information Element (“IE”);

FIG. 7 is a diagram illustrating one embodiment of a configured uplink grant configuration comprising of two periodicities;

FIG. 8A is a diagram illustrating one embodiment of ASN.1 form for a ConfiguredGrantConfig IE;

FIG. 8B is a continuation of the ConfiguredGrantConfig IE of FIG. 8A;

FIG. 9 is a block diagram illustrating one embodiment of a user equipment apparatus that may be used for SDT procedure using CG resources;

FIG. 10 is a block diagram illustrating one embodiment of a network apparatus that may be used for SDT procedure using CG resources; and

FIG. 11 is a flowchart diagram illustrating one embodiment of a first method for SDT procedure using CG resources.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for configuring a User Equipment (“UE”) with CG-SDT resources (i.e., CG resources for SDT procedure). In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As noted above, NR supports RRC_INACTIVE state and UEs with infrequent (periodic and/or non-periodic) data transmission are generally maintained by the network in the RRC_INACTIVE state. However so far, the RRC_INACTIVE state does not support the transmission of data. Hence, the UE has to resume the connection (i.e., move to RRC_CONNECTED state) for any downlink (“DL”) (e.g., Mobile Terminating) and uplink (“UL”) (e.g., Mobile Originating) data. If small-data transmission in the RRC_INACTIVE state is not supported, then the UE is required to setup an RRC connection (i.e., move to RRC_CONNECTED state) and subsequently be released to the RRC_INACTIVE state for each data transmission regardless of how small and infrequent the data packets are. This results in unnecessary power consumption and signaling overhead.

In various embodiments, small data transmission (“SDT”) is supported while the UE is in RRC_INACTIVE state. In some embodiments, said UL small data transmissions are achieved using RACH-based schemes (i.e., 2-step and 4-step random access procedures). In one embodiment, user plane (“UP”) data transmission for small data packets from the RRC_INACTIVE state uses, e.g., the MsgA (i.e., for 2-step random access procedure) or Msg3 (i.e., for 4-step random access procedure).

Random-Access Channel (“RACH”) messaging may be modified to enable flexible payload sizes larger than the Rel-16 Common Control Channel (“CCCH”) message size that is possible currently for the RRC_INACTIVE state for MsgA and Msg3 to support user plane data transmission in UL (actual payload size can be up to network configuration). In one embodiment, context fetch and data forwarding (with and without anchor relocation) may occur in RRC_INACTIVE state for RACH-based solutions.

In some embodiments, transmission of UL data on pre-configured Physical Uplink Shared Channel (“PUSCH”) resources is supported (i.e., reusing the configured grant (“CG”) Type-1)—when the uplink Timing Alignment (“TA”) is valid. In one embodiment, small data transmissions are achieved over CG Type-1 resources from RRC_INACTIVE state. A UE may be configured with CG Type-1 resources for small data transmission in UL for RRC_INACTIVE state

The present disclosure addresses the following problem with small-data transmission when the UE is in the RRC_INACTIVE state:

For CG-SDT operation, gNB allocates CG-SDT resources in the RRCRelease message in accordance with the traffic pattern of the SDT bearers. So far, the CG-SDT resource configuration is only allocating CG PUSCH for the initial SDT transmission. However, it should be also possible to transmit subsequent UL SDT data within a SDT session on CG-SDT resources. Furthermore, the UE should be only allowed to send subsequent UL SDT data once the reception of the initial SDT message (i.e., SDT transport block (“TB”)) was confirmed by the gNB.

Described herein are solution to support small-data transmission (“SDT”) in the RRC_INACTIVE state using CG-SDT resources. In various embodiments, the network configures CG-SDT resource(s) by using a configured grant configuration being comprised of two periodicities. UE considers only the first periodicity—as in the legacy—for determining the CG-SDT resources when being in RRC_INACTIVE state and before having initiated a SDT session/procedure, i.e., the CG-SDT resources are only used for the initial SDT message. Upon initiation of the SDT procedure and in response to having transmitted the first/initial SDT TB on the CG-SDT resource, UE activates the further CG-SDT resources according to the second configured periodicity. UE performs retransmission of the initial SDT TB or to transmission of any further subsequent SDT UL data/TBs on the subsequent CG-SDT resources.

By configuring multiple periodicities, the network does not need to configure the UE multiple CG-SDT configurations in order to allocate multiple CG-PUSCH resources within a CG period, e.g., CG PUSCH resources for the initial SDT message as well as for the subsequent UL SDT data transmissions. This is beneficial because the multiple CG-SDT configurations would come at the expense of an increased signaling overhead.

In some embodiments, the UE skips the transmission of a generated TB on an allocated uplink resource, e.g., CG-SDT resource, when the transmission of the TB on the first CG-SDT resource of a SDT session has not been confirmed by the gNB. In one specific implementation the first uplink transmission on the first CG-SDT resource of a SDT session is comprised of at least CCCH data, e.g., RRCResumeRequest message. TB(s) which UE skips due to a missing confirmation received from the gNB for the initial CG-SDT transmission, are kept pending in the Hybrid Automatic Repeat Request (“HARQ”) buffer and autonomously retransmitted by the UE once the confirmation is received from the gNB (i.e., a 5G base station).

In some embodiments, a CG-SDT resource configuration is a Type 1 Configured Grant configuration however there is one additional periodicity within the CG-SDT configuration. The UE considers the first periodicity for determining the CG-SDT resources when being in RRC_INACTIVE state and before having initiated a SDT session/procedure, i.e., the CG-SDT resources are only used for the initial SDT message. Upon initiation of the SDT procedure and in response to having transmitted the first/initial SDT TB on the CG-SDT resource, UE activates the further CG-SDT resources according to the second configured periodicity.

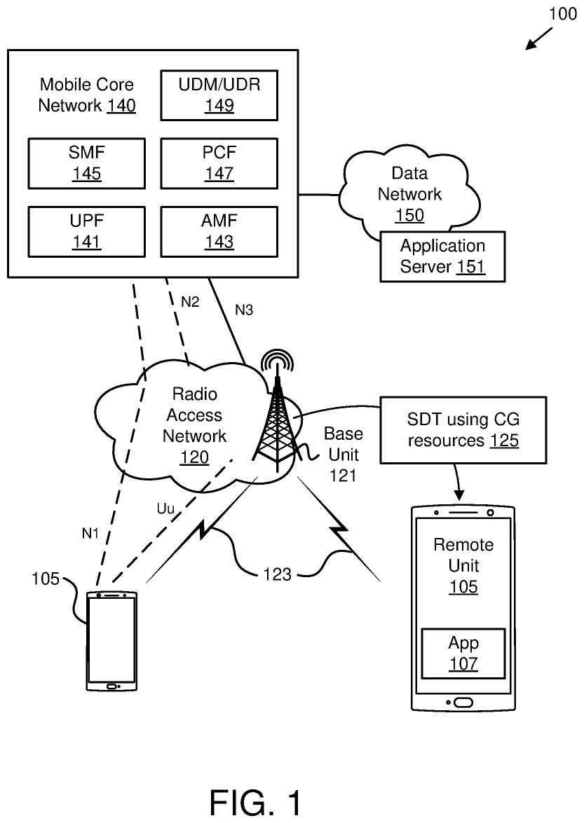

FIG. 1 depicts a wireless communication system 100 for SDT procedure using CG resources, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication networks, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more uplink channels, such as the Physical Uplink Control Channel (“PUCCH”) and/or PUSCH, while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication (not shown in FIG. 1). Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframes, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a Single Network Slice Selection Assistance Information (“S-NSSAI”), while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

To facilitate SDT procedure using CG resources, the base unit 121 may transmit a SDT configuration to a remote unit 105, where the remote unit 105 uses the SDT configuration to determine whether to transmit small data in RRC_INACTVE using, e.g., CG resources for SDT (“CG-SDT”) 125 or to move to the RRC_CONNECTED state to perform uplink data transmission.

While FIG. 1 depicts components of a 5G RAN and a 5G core network, the described embodiments for SDT procedure using CG resources apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems SDT procedure using CG resources.

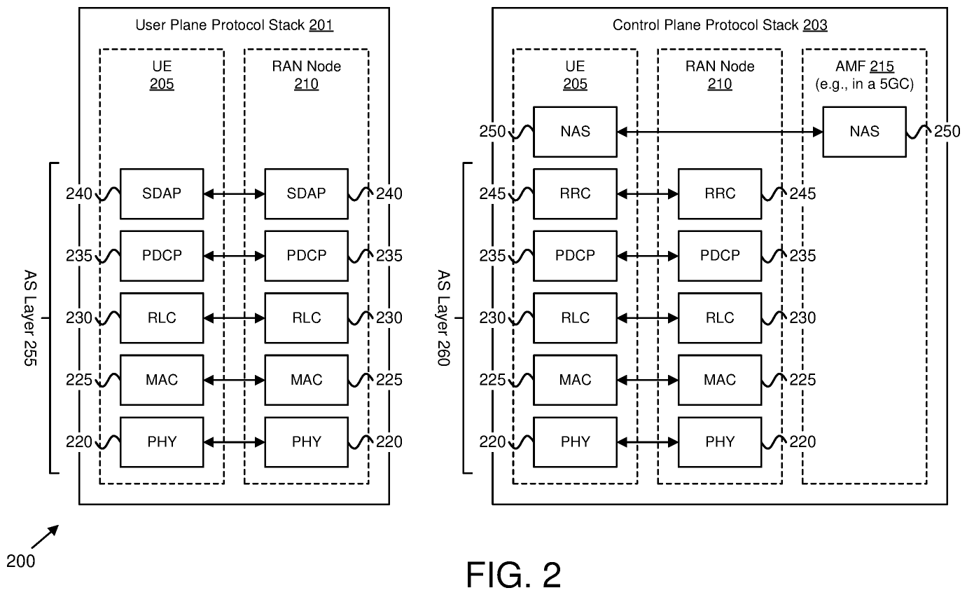

FIG. 2 depicts an NR protocol stack 200, according to embodiments of the disclosure. While FIG. 2 shows the UE 205, the RAN node 210 and an AMF 215 in a 5G core network (“5GC”), these are representatives of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes an RRC layer 245 and a NAS layer 250.

The Access Stratum (“AS”) layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of PRBs, etc.

For RACH-based and CG-based SDT, when the UE 205 receives RRC release with a Suspend configuration, the UE 205 performs at least the following actions:
MAC is reset and default MAC cell group configuration is released
RLC entities for Signaling Radio Bearer #1 (“SRB1”) are re-established. SRBs and DRBs are suspended except for Signaling Radio Bearer #0 (“SRB0”)

For both RACH- and CG-based SDT, upon initiating the RESUME procedure for SDT initiation (i.e., for the first/initial SDT transmission), the UE 205 shall re-establish at least the SDT PDCP entities and resume the SDT DRBs that are configured for small data transmission (along with the SRB1).

The first UL message (i.e., MSG3 for 4-step RACH, MSGA payload for 2-step RACH and the CG transmission for CG) may contain at least the following contents (depending on the size of the message):
CCCH message (required).
DRB data from one or more DRBs which are configured by the network for small data transmission (optional)
MAC Control Elements (“CEs”)—(e.g., Buffer Status Report (“BSR”)) (optional)
Padding bits (optional)

Logical Channel Prioritization (“LCP”) can be used to determine the priority of the above content that may be included.

For RACH and CG, the existing Unified Access Control (“UAC”) procedure to determine whether access attempt is allowed, will be reused for SDT.

SDT is transparent to NAS layer (i.e., NAS generates one of the existing resume causes and AS layer decides SDT vs non-SDT access).

In case of RRC-based solution, for both RACH- and CG-based SDT, the CCCH message contains Message Authentication Code-Integrity for Resume (“resumeMAC-I”) generated using the stored security key for RRC integrity protection—i.e., same as Rel-16.

For both RACH- and CG-based SDT, new keys are generated using the stored security context and the Next Hop Chaining Counter (“NCC”) value received in the previous RRCRelease message and these new keys are used for generating the data of DRBs that are configured for SDT.

For RACH-based SDT, upon successful completion of contention resolution, the UE 205 shall monitor the Cell-specific Radio Temporary Network Identifier (“C-RNTI”). In one embodiment, the coreset/search space for the C-RNTI is a common (i.e., shared) coreset/search space. In another embodiment, the coreset/search space for the C-RNTI is a dedicated coreset/search space.

As a baseline, the RACH resource i.e., (Random Access Occasion (“RO”)+preamble combination) is different between SDT and non-SDT. If Random Access Occasions (“ROs”) for SDT and non SDT are different, preamble partitioning between SDT and non SDT is not needed. However, if ROs for SDT and non SDT are same, preamble partitioning is needed.

Note that if the RACH resource i.e., (RO+preamble combination) is different between SDT and non-SDT, then there is no further need for any differentiation between Msg2/MsgB for SDT vs non-SDT.

The configuration of configured grant resource for the UE 205 uplink small data transfer is contained in the RRCRelease message. Configuration may be only Type-1 CG with no contention resolution procedure for CG.

The configuration of configured grant resource can include one Type-1 CG configuration. In some embodiments, multiple configured CGs are allowed.

A new TA timer for TA maintenance specified for configured grant based small data transfer in RRC_INACTIVE should be introduced. The TA timer is configured together with the CG configuration in the RRCRelease message.

The configuration of configured grant resource for the UE 205 small data transmission is valid only in the same serving cell.

The UE 205 can use configured grant based small data transfer if at least the following criteria is fulfilled: (1) user data is smaller than the data volume threshold; (2) configured grant resource is configured and valid; and (3) the UE 205 has valid TA.

A Synchronization Signal Reference Signal Received Power (“SS-RSRP”) threshold is configured for Synchronization Signal Block (“SSB”) selection. The UE 205 selects one of the SSB with SS-RSRP above the threshold and selects the associated CG resource for UL data transmission. In certain embodiments, an association between CG resources and SSB is required for CG-based SDT.

The Rel-16 CG configuration mechanism in licensed band is reused the baseline for CG-SDT. At least for initial transmission we will have a mechanism to allow the UE 205 to transmit the message again. The UE 205 uses/selects the same HARQ process for retransmission.

The “CG-SDT timer” starts at the first “valid” PDCCH occasion from the end of the CG-SDT PUSCH transmission. The “CG-SDT timer” can be started/restarted during for initial and subsequent transmissions.

The UE 205 restarts the “CG-SDT timer” at least upon the PUSCH retransmission indicated by the Configured Scheduling Radio Network Temporary Identifier (“CS-RNTI”) PDCCH and/or after each CG-SDT transmission. The “CG-SDT timer” stops at least when the UE 205 receives RRC feedback messages (e.g., RRCResume, RRCSetup, RRCRelease and RRCReject). Note that the Rel-16 calculation on the HARQ process identifier (“ID”) of the CG type-1 for licensed band may be reused as the baseline for CG-SDT.

The UE 205 may be allowed to initiate subsequent UL data transmission only after the reception of confirmation of initial transmission from the RAN node 210. The UE 205 may use multiple CG resources for the HARQ initial transmission as Rel-16 in the subsequent CG transmission phase.

The following CG-SDT configurations are per UE: the new TA timer in RRC_INACTIVE, the Reference Signal Received Power (“RSRP”) change threshold for TA validation mechanism in SDT, and the SSB RSRP threshold for beam selection.

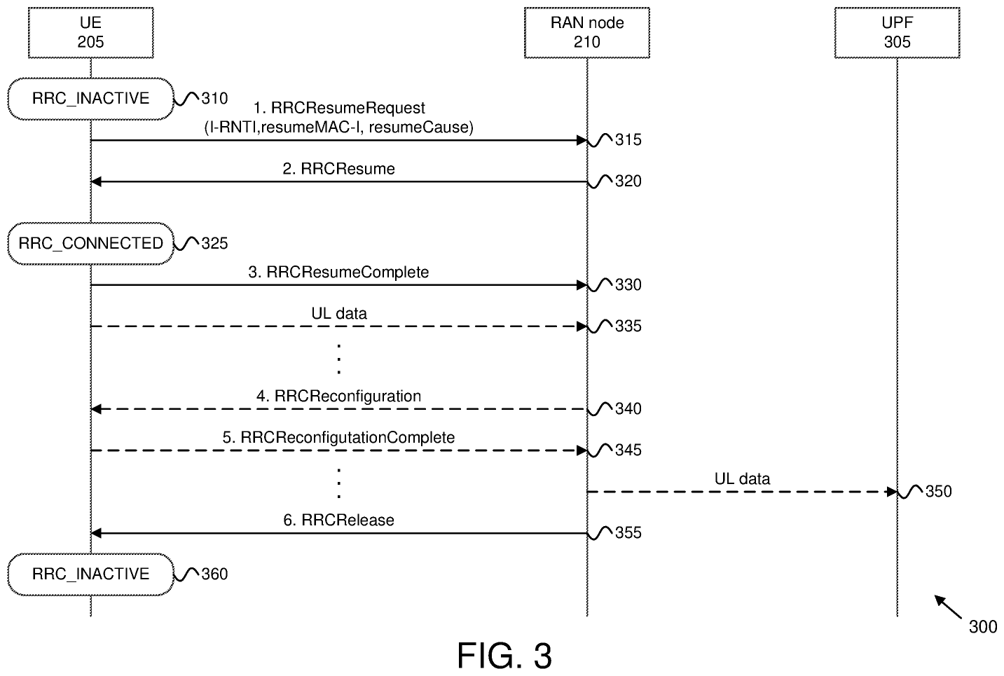

FIG. 3 depicts an example RRC Resume procedure 300. The procedure 300 involves the UE 205 (e.g., an instance of the remote unit 105), the RAN node 210 (e.g., an instance of the base unit 121), and a UPF 305 (e.g., an instance of the UPF 141). At the beginning of the procedure 300, the UE 205 is in the RRC_INACTIVE state (see block 310). Note that the RRC state of the UE 205 is known to both the UE 205 and the RAN node 210.

At Step 1, the UE 205 sends an RRCResume Request message to the RAN node 210 (see messaging 315). As depicted, the RRCResumeRequest comprises an Inactive Radio Network Temporary Identifier (“I-RNTI”), resumeMAC-I, and a resumeCause.

At Step 2, the RAN node 210 transmits an RRCResume message to the UE 205 (see messaging 320). The UE 205 transitions to the RRC_CONNECTED state in response to the RRCResume message (see block 325).

At Step 3, the UE 205 sends an RRCResumeComplete message to the RAN node 210 in response to transitioning to the RRC_CONNECTED state (see messaging 330). Optionally, the UE 205 sends one or more messages comprising UL data (see messaging 335).

At Step 4, the RAN node 210 transmits an RRCReconfiguration message to the UE 205 (see messaging 340). In some embodiments, the RRCReconfiguration message releases radio bearers used to transfer the UL data.

At Step 5, the UE 205 sends an RRCReconfigutationComplete message to the RAN node 210 (see messaging 345). Note that the RAN node 210 forwards the UL data to the UPF 305 (see messaging 350).

At Step 6, the RAN node 210 transmits an RRCRelease message to the UE 205 (see messaging 355), e.g., with SuspendConfig IE. In some embodiments, the RRCRelease message comprises a configuration for configured uplink grant (i.e., for CG resources). The UE 205 transitions to the RRC_INACTIVE state in response to the RRCRelease message (see block 360).

As noted above, current 3GPP specifications require that connection setup and subsequent release to RRC_INACTIVE state happens for each data transmission however small and infrequent the data packets are.

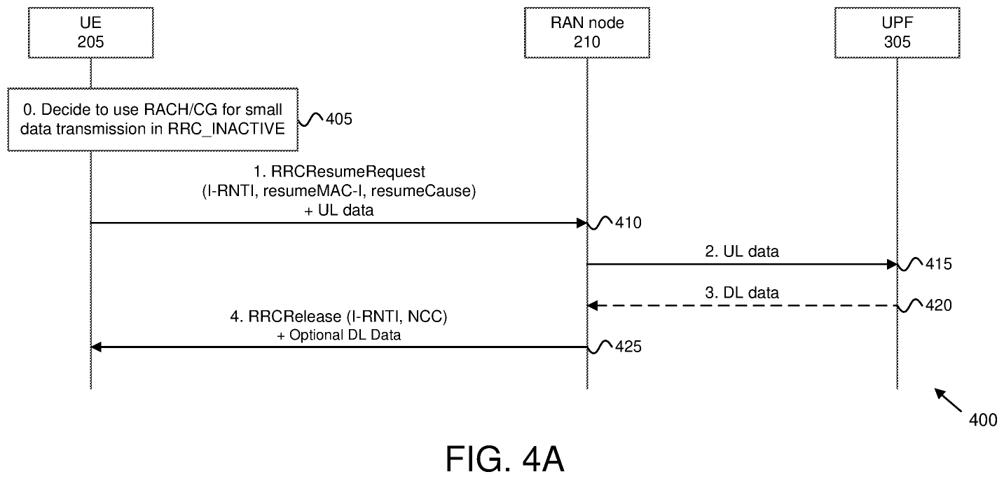

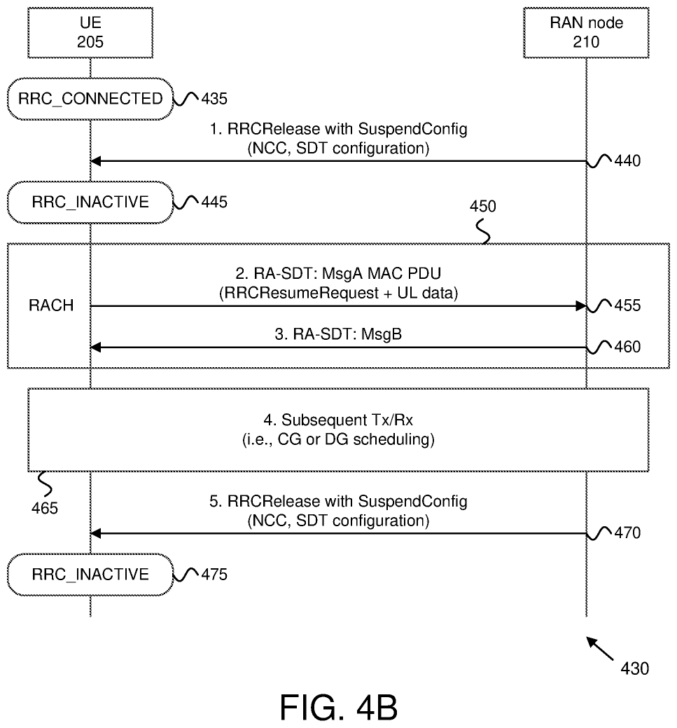

FIG. 4A depicts an exemplary Small Data Transmission (“SDT”) procedure 400 of a UE 205 in the RRC_INACTIVE state. The procedure 400 involves the UE 205 (e.g., an instance of the remote unit 105), the RAN node 210 (e.g., an instance of the base unit 121), and the UPF 305 (e.g., an instance of the UPF 141). At the beginning of the procedure 400, the UE 205 is in the RRC_INACTIVE state. The depicted procedure 400 is based on Random Access (“RA”) resources (i.e., on the Random Access Channel (“RACH”)) and/or Configured Grant (“CG”) resources.

At Step 0, the UE 205 determines to use RACH or CG resources for small data transmission in RRC_INACTIVE (see block 405). At Step 1, the UE 205 sends a RRCResumeRequest with UL data (and NCC value) to the RAN node 210 while in the RRC_INACTIVE state (see messaging 410). As depicted, the RRCResumeRequest comprises an RNTI, resumeMAC-I, and a resumeCause.

At Step 2, the RAN node 210 forwards the UL data to the 5GC (i.e., to UPF 305) (see messaging 415). At Optional Step 3, the UPF 305 sends DL data for the UE 205 to the RAN node 210 (see messaging 420).

At Step 4, the RAN node 210 sends a RRCRelease message to the UE 205 (see messaging 425). As depicted, the RRCRelease message comprises an I-RNTI and new NCC value. Where the UPF has DL data for the UE 205 (or where DL data for the UE 205 is buffered at the RAN node 210), the RRCRelease message contains DL data.

FIG. 4B depicts another exemplary Small Data Transmission (“SDT”) procedure 430 of a UE 205 in the RRC_INACTIVE state. The depicted procedure is based on Random Access Channel (“RACH”) resources configured for SDT. The procedure 430 involves the UE 205 (e.g., an instance of the remote unit 105) and the RAN node 210 (e.g., an instance of the base unit 121). At the beginning of the procedure 430, the UE 205 is in the RRC_CONNECTED state (see block 435).

At Step 1, the RAN node 210 sends a RRCRelease message with SuspendConfig IE (see messaging 440), and the UE 205 moves from the RRC_CONNECTED state to the RRC_INACTIVE state (see block 445). Here, the RRCRelease message with SuspendConfig IE contains an SDT configuration (and a NCC value).

At a later time, the UE 205 determines to use a RACH-based SDT procedure 450 for small data transmission in RRC_INACTIVE. At Step 2, the UE 205 sends to the RAN node 210 a RA-SDT message (i.e., a MsgA of a 2-step Random Access (“RA”) procedure) that contains a RRCResumeRequest message with UL data (see messaging 455). Here it is assumed that the UE 205 has additional data to transmit.

At Step 3, the RAN node 210 responds to the UE 205 with a RA-SDT message (i.e., a MsgB of the 2-step RA procedure) (see messaging 460). At Step 4, the UE 205 performs subsequent data transmission(s) using resources allocated by configured grant (“CG”) and/or dynamic grant (“DG”) (see block 465). Where the network has DL data for the UE 205 (e.g., where DL data for the UE 205 is buffered at the RAN node 210), the “subsequent data transmission(s)” of block 465 include DL data transmission by the RAN node 210.

At Step 5, upon completion of the subsequent data transmission(s), the RAN node 210 sends another RRCRelease message to the UE 205, again containing a SDT configuration for RACH resources (and a NCC value) (see messaging 470). The UE 205 moves to the RRC_INACTIVE state upon receiving the RRCRelease message (see block 475), e.g., the UE 205 keeps staying in the RRC_INACTIVE state.

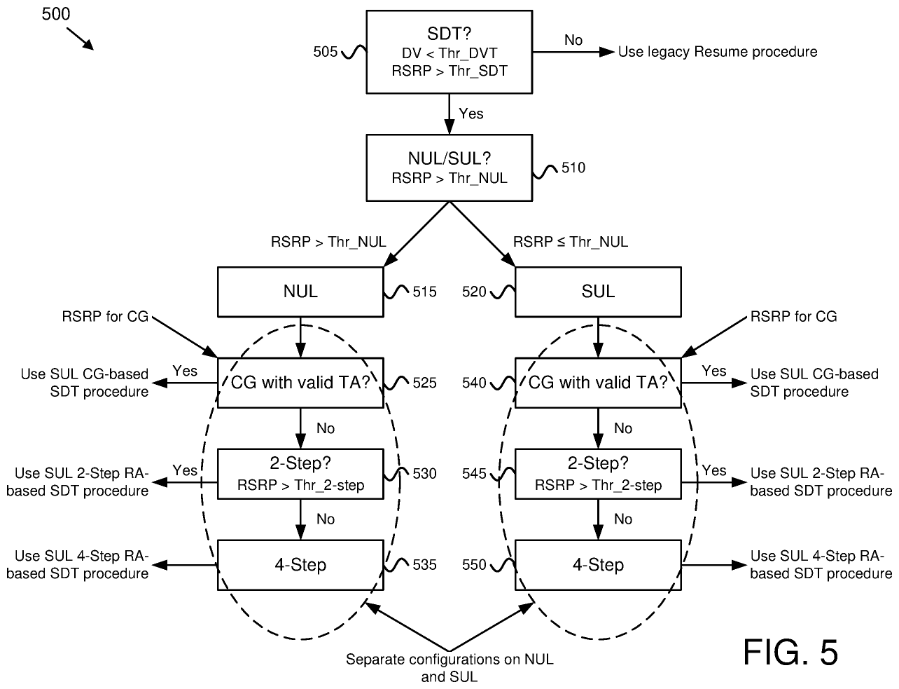

FIG. 5 depicts an exemplary procedure 500 for the selection of SDT resources, i.e., the UE 205 determines whether to use CG-based SDT or RACH-based SDT or non-SDT, based on data volume and RSRP values.

As an initial decision, the UE 205 determines whether to use an SDT procedure by comparing the data volume to a data volume threshold and also comparing a measured RSRP to a SDT threshold (see block 505). The RSRP threshold is to guarantee that the 4-Step RACH-based procedure (corresponding to the lowest threshold) can be performed. If the amount of user data is smaller than the data volume threshold and the RSRP is above the SDT threshold, then the UE 205 can use the SDT procedure and moves to selecting SDT resources. Otherwise, the UE 205 determines to use the legacy resume procedure depicted in FIG. 3.

To select the SDT resources, the UE 205 selects a carrier (i.e., determines whether to use normal (i.e., non-supplementary) uplink carrier (“NUL”) or supplementary uplink carrier (“SUL”)), if configured, by comparing the RSRP to the NUL threshold (see block 510). If the RSRP is greater than the NUL threshold, then the UE 205 selects the NUL as the carrier for the SDT procedure (see block 515). Otherwise, if the RSRP is less than or equal to the NUL threshold, them the UE 205 selects the SUL as the carrier for the SDT procedure (see block 520).

Upon selecting the NUL, the UE 205 decides whether to use a CG-based procedure by determining the RSRP is sufficient for CG operation and whether the UE 205 has a valid TA for the CG (see block 525). If yes, then the UE 205 uses a NUL CG-based SDT procedure, for example as depicted in FIG. 4A. If no, then the UE 205 uses a NUL RACH-based SDT procedure.

Upon selecting the NUL RACH-based SDT procedure, the UE 205 decides whether to use a 2-step RACH procedure by comparing the RSRP to the 2-Step threshold (see block 530). If yes, then the UE 205 uses a NUL 2-Step RACH-based SDT procedure, for example as depicted in FIG. 4B. If no, then the UE 205 uses a NUL 4-step RACH-based SDT procedure (see block 535).

However, upon selecting the SUL, the UE 205 decides whether to use a CG-based procedure by determining the RSRP is sufficient for CG operation and whether the UE 205 has a valid TA for the CG (see block 540). If yes, then the UE 205 uses a SUL CG-based SDT procedure, for example as depicted in FIG. 4A. If no, then the UE 205 uses a SUL RACH-based SDT procedure.

Upon selecting the SUL RACH-based SDT procedure, the UE 205 decides whether to use a 2-step RACH procedure by comparing the RSRP to the 2-Step threshold (see block 545). If yes, then the UE 205 uses a NUL 2-Step RACH-based SDT procedure, for example as depicted in FIG. 4B. If no, then the UE 205 uses a NUL 4-step RACH-based SDT procedure (see block 550). Note that the UE 205 may have separate configurations on NUL and SUL, thus the thresholds used for NUL CG and NUL 2-Step determination may be different than the thresholds used for SUL CG and SUL 2-Step determination.

According to embodiments of a first solution, the UE 205 skips the transmission of a generated TB on an allocated uplink resources, e.g., PUSCH resources, for cases that the confirmation that a previous uplink transmission was correctly received was not received yet. In one implementation of the first solution, the allocated uplink resource is a configured uplink grant, i.e., CG-PUSCH. In a further implementation of the first solution, the UE 205 skips the transmission of a generated TB on an allocated uplink resource, e.g., CG-SDT resource, when the transmission of the TB on the first CG-SDT resource of a SDT session/procedure has not been confirmed by the RAN node 210.

In some embodiments, the confirmation may be by means of HARQ Ack, L2 Ack or a new DL/UL assignment with toggled New Data Indicator (“NDI”). In one specific implementation, the first uplink transmission on the first CG-SDT resource of a SDT session is comprised of at least CCCH data, e.g., RRCResumeRequest message.

According to the first solution the UE 205 is only allowed to make subsequent UL data transmissions once the first uplink transmission of a SDT session on the first CG-SDT resource has been confirmed/acknowledged by the RAN node 210, e.g., response message confirming the reception of the initial CG-SDT transmission containing e.g., the RRCResume Request message.

According to one implementation of the first solution, TB(s) which the UE 205 skips due to a missing (or not yet received) confirmation from the RAN node 210 for the initial CG-SDT transmission, e.g., first UL transmission within a SDT session containing at least a RRCResumeRequest message, are kept pending in the HARQ buffer and autonomously retransmitted by the UE 205 once the confirmation is received from the RAN node 210. The “skipping” or “suppressing” of subsequent uplink data until the reception of a confirmation for the initial SDT transmission, e.g., RRCResumeRequest, is implemented in the UE 205 (e.g., at the MAC entity) similarly to the Listen-Before-Talk (“LBT”) failure case. A HARQ process may be set to ‘pending’ in response to skipping on UL transmission of subsequent UL data due to a missing confirmation of the initial SDT message/TB.

According to embodiments of a second solution, the UE 205 is not allowed to generate a transport block for subsequent UL data as long as the confirmation of the initial SDT UL transmission, e.g., first TB of a CG-SDT procedure including e.g., RRCResume Request message, has not been received from the RAN node 210. In other words, the UE 205 may suppress processing a subsequent configured uplink grant allocated for small data transmission for an initial new transmission of subsequent uplink data of the SDT procedure. For cases that the UE 205 has data available for transmission in its buffer (e.g., PDCP/RLC buffer), e.g., data of SDT bearers, as well as allocated UL resources, e.g., CG-SDT resources, the UE 205 does not perform LCP procedure and generate new TBs as long as the initial TB of a CG-SDT session carrying, e.g., the RRCResumeRequest message, has not been confirmed by the RAN node 210. As used herein, a CG-SDT session refers to a SDT procedure that uses CG resources. In the following descriptions, the terms “SDT session” and “SDT procedure” may be used interchangeably to refers to the transfer of data units in the RRC_INACTIVE state.

According to one implementation of the second solution, PUSCH allocations, e.g., CG-SDT resources, are considered as not valid for the transmission of new TBs (i.e., initial new transmissions) as long the initial TB has not been acknowledged by the RAN node 210. Considering an PUSCH allocation (e.g., CG-SDT resource) as not valid (invalid) means that the UE 205 will ignore the PUSCH allocation and will not generate a TB for the PUSCH allocation nor perform an UL (PUSCH) transmission corresponding to the PUSCH allocation.

According to another implementation of the second solution, the UE 205 ignores UL grants/allocations, e.g., dynamic UL grant(s) conveyed within a Downlink Control Information (“DCI”), as long as the confirmation of the reception of the initial TB of the corresponding CG-SDT session has not been received from the RAN node 210. Ignoring an UL grant/allocation means that the UE 205 will not generate of TB for the UL grant/allocation nor perform an UL (PUSCH) transmission corresponding to the PUSCH allocation.

According to some alternative implementation of the second solution, the UE 205 suspends any allocated PUSCH resources, e.g., CG-SDT resources, for the transmission of new TB(s) as long as the confirmation for the initial TB of a CG-SDT session (e.g., corresponding the SDT procedure) was not received from the RAN node 210, i.e., the RAN node 210 has not confirmed the reception of the initial TB (e.g., RRCResumeRequest message). Upon reception of the confirmation of the reception of the initial TB, the UE 205 resumes or re-initializes any allocated PUSCH resources, e.g., CG-SDT resources. Accordingly, the UE 205 can use the CG-SDT resource or any other allocated PUSCH resources for the transmission of subsequent UL data, i.e., new TB(s).

According to some further alternative implementation of the second solution, the UE 205 considers any Uplink HARQ processes except the HARQ process which is used for the transmission of the initial SDT TB, e.g., TB containing the RRCResumeRequest message, as suspended or deactivated upon initiation of the CG-SDT session. Considering an UL HARQ process as deactivated or suspended means that the HARQ process cannot be used for an UL (PUSCH) transmission. Upon reception of the confirmation of the reception of the initial TB (e.g., RRCResumeRequest message) from the RAN node 210, the UE 205 considers any UL HARQ process as active. Consequently, the UE 205 can use any UL HARQ process for the transmission of new UL data.

According to one embodiment, the confirmation of the initial SDT message, e.g., TB containing RRCResumeRequest message, may be one of the following:
PDCCH scheduling some initial PDSCH transmission: If there is some DL data for the UE 205 (e.g., in response to the initial SDT message), then the confirmation may be PDCCH that schedules PDSCH for the DL data.
PDCCH scheduling some initial PUSCH transmission: if there is BSR in the first UL message, then the confirmation may be PDCCH that includes a grant for further UL data.
PDSCH containing a RRCRelease message: if there is no subsequent DL or UL, the network may want to terminate the SDT procedure immediately (i.e., everything is complete). In such embodiments, the DL response may be RRCRelease scheduled using PDCCH addressed to C-RNTI.
PDSCH containing a Timing Advance Command (“TAC”): if the network is waiting for DL or (further) UL traffic and wants to keep the UE 205 in SDT for now (e.g., during the wait time), then the confirmation could also be something simple like a TAC MAC Control Element (“CE”) addressed to the UE 205 directly, or similar.

According to embodiments of a third solution, a logical channel is configured with a parameter indicating whether autonomous retransmission(s) are supported for data of this logical channel. For cases that a logical channel (“LCH”) configuration indicates that autonomous retransmission(s) are supported for the corresponding LCH, the UE 205 may autonomously retransmit a TB containing data of the corresponding LCH, e.g., when reception of the TB was not explicitly confirmed by a feedback message or transmission of the TB could not take place (skipped) due to some channel unavailability.

According to one implementation of the third solution, the UE 205 (e.g., at the MAC entity) supports autonomous retransmissions for a TB in case there is at least data of one LCH in the TB which supports autonomous retransmission(s) according to the LCH configuration. In one specific implementation of the third solution, the new parameter is a new field in the IE LogicalChannelConfig. Some exemplary implementations of the new parameter in 3GPP specifications according to the third solutions is shown below:

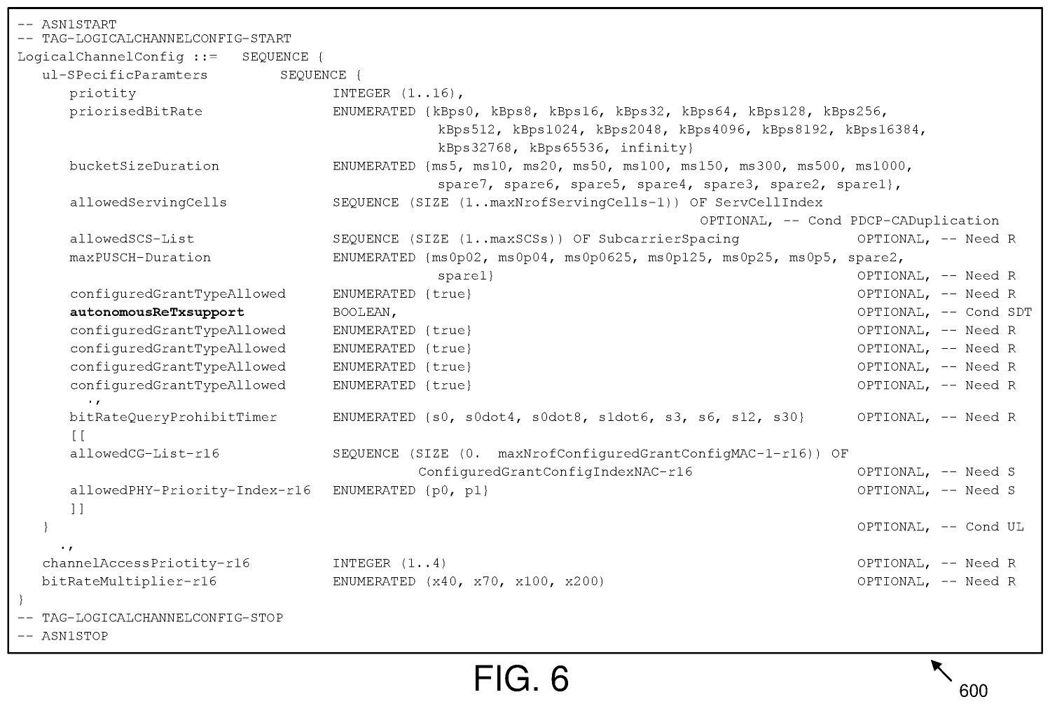

FIG. 6 depicts an ASN.1 representation 600 of an exemplary IE LogicalChannelConfig that may be used to configure the logical channel parameters.

Configuring per LCH whether some autonomous retransmission functionality is supported allows the network (e.g., the RAN node 210 or 5GC) to control on a finer granularity for which kind of data autonomous retransmission should be supported by the UE 205. For example, for SDT, the network (e.g., the RAN node 210 or 5GC) can ensure by the new LCH parameter that the UE 205 is only allowed to (autonomously) retransmit the initial TB of a SDT session, e.g., TB containing RRCResumeRequest message, but not for any subsequent UL data.

According to embodiments of a fourth solution, a configured uplink grant configuration is comprised of two periodicities. In one implementation of the fourth solution multiple CG PUSCH resources are configured within one CG period. In one implementation of the fourth solution, the two periodicities are configured for configured grant configurations used for SDT, i.e., CG-SDT. Configured grants for the transmission of small data in RRC_INACTIVE, i.e., CG-SDT, are based on the CG Type-1 configuration specified in Rel-15 NR. Basically, the UL data transmission on CG-SDT resources is based on RRC reconfiguration without any L1 signaling. RRC provides the grant configuration to the UE 205 through higher layer IE ConfiguredGrantConfig including the parameter rrc-ConfiguredUplinkGrant without the detection of any UL grant in a DCI, e.g., there is no specific Activation/Release procedure. The CG-SDT resources are signaled to the UE 205 for example in the RRCRelease message, i.e., sending the UE 205 to RRC_INACTIVE. In the legacy NR, RRC configures the following parameters when the CG Type-1 is configured:
cs-RNTI: this parameter indicates the CS-RNTI for retransmission;
periodicity: this parameter indicates the periodicity of the CG Type-1;
timeDomainOffset: this parameter indicates the offset of a resource with respect to System Frame Number (“SFN”)=0 in time domain;
timeDomainAllocation: this parameter indicates the allocation of configured uplink grant in time domain which contains startSymbolAndLength
nrofHARQ-Processes: this parameter indicates the number of HARQ processes for configured grant.

According to the fourth solution, a second periodicity is configured by RRC for the CG-SDT resources. According to one implementation of the fourth solution, the first periodicity (existing periodicity) configures the CG resources for the initial SDT CG-PUSCH transmission of a SDT session and the new second periodicity configures the CG-SDT resources within a SDT session, e.g., for subsequent UL data transmission or the retransmission of the initial SDT message/TB. It should be noted that there may be multiple subsequent CG-SDT PUSCH resources within a SDT procedure which can be used for the transmission of subsequent UL data.

The first periodicity refers to the periodicity with which small data arrives in the UE 205 while being in the RRC_INACTIVE state. To give an example how the two periodicities may be used: If a smart sensor reports some sensor data every 1 s, then the first periodicity is set to 1 s. In order to report the sensor data several uplink transmissions are necessary such that multiple CG-SDT are configured within a SDT session. The second periodicity refers to the periodicity of CG-SDT resources within a SDT session.

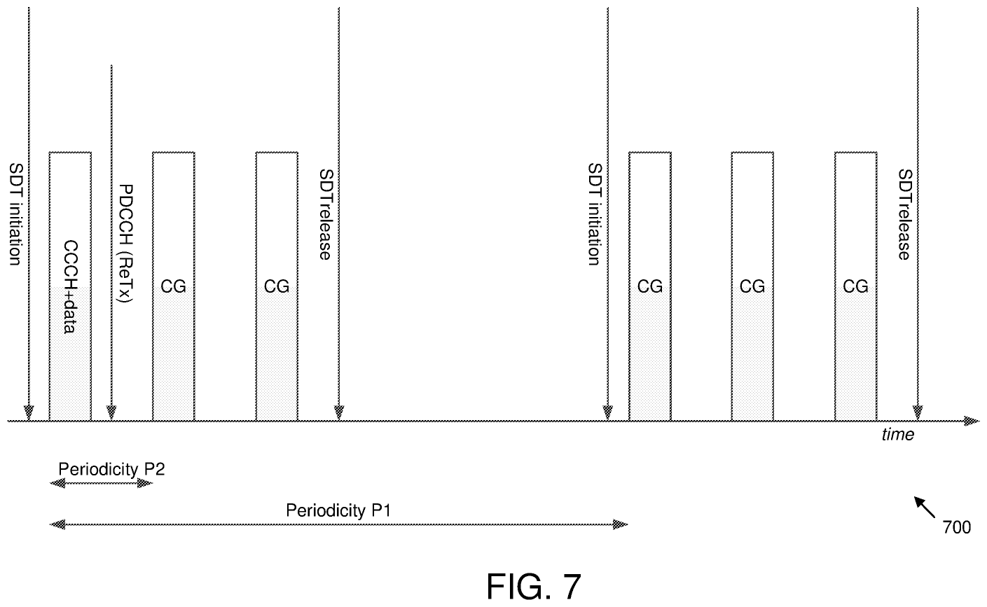

FIG. 7 depicts a configured uplink grant configuration 700 comprising two periodicities. As shown in FIG. 7, there are multiple CG PUSCH resources configured within the first CG periodicity. The first periodicity (denoted “P1”) is between consecutive sets of CG-SDT resources while the second periodicity (denoted “P2”) is between adjacent CG-SDT resources in a set. As depicted, the SDT session begins with SDT initiation and ends with SDTrelease (e.g., comprising a RRCRelease message).

According to one implementation of the fourth solution, the UE 205 considers only the first periodicity—as in the legacy—for determining the CG-SDT resources when being in RRC_INACTIVE state and before having initiated a SDT session/procedure, i.e., the CG-SDT resources are only used for the initial SDT TB comprised of e.g., the RRCResume Request message.

Upon initiation of the SDT procedure and in response to having transmitted the first/initial SDT TB on the CG-SDT resource (determined according to the first periodicity), the UE 205 will activate the further CG-SDT resources according to the second configured periodicity (i.e., P2). The UE 205 is allowed to retransmit the initial SDT TB or to transmit any further subsequent SDT UL data/TBs on the subsequent CG-SDT resources allocated according to the second periodicity.

Once the SDT session/procedure is finished, i.e., upon reception of the RRCRelease message, or any other RRC message received from the network keeping the UE 205 in RRC_INACTIVE, the UE 205 deactivates/suspends the CG-SDT resources according to the second periodicity; the CG-SDT resources according to the first periodicity remain active unless the RAN node 210 initiates transition of the UE 205 to a different RRC state like RRC_IDLE or RRC_CONNECTED.

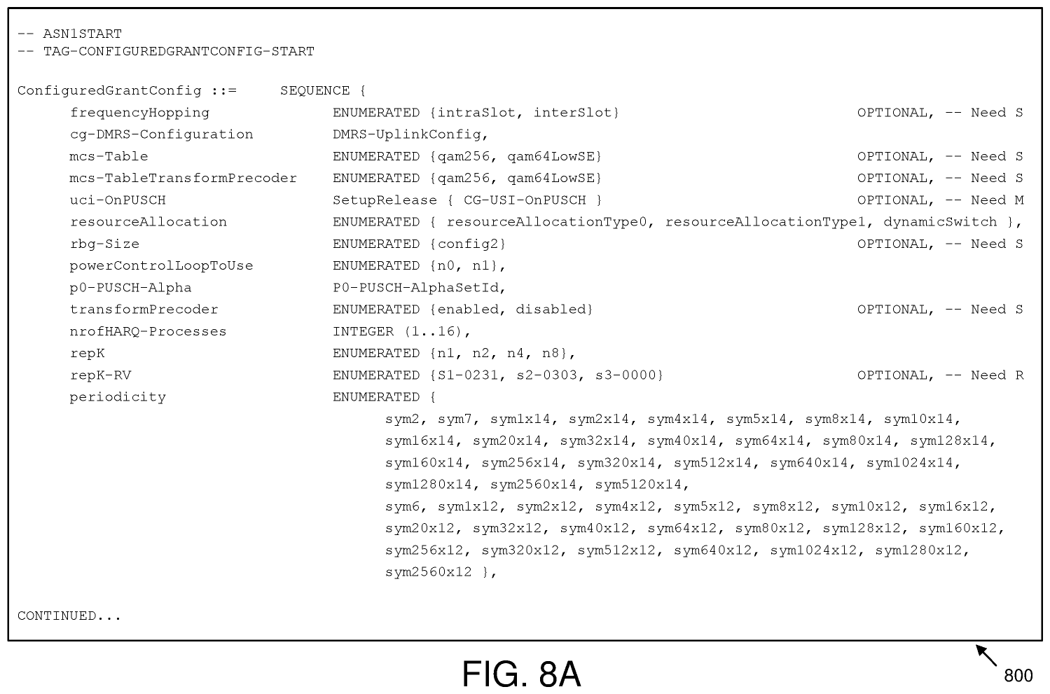

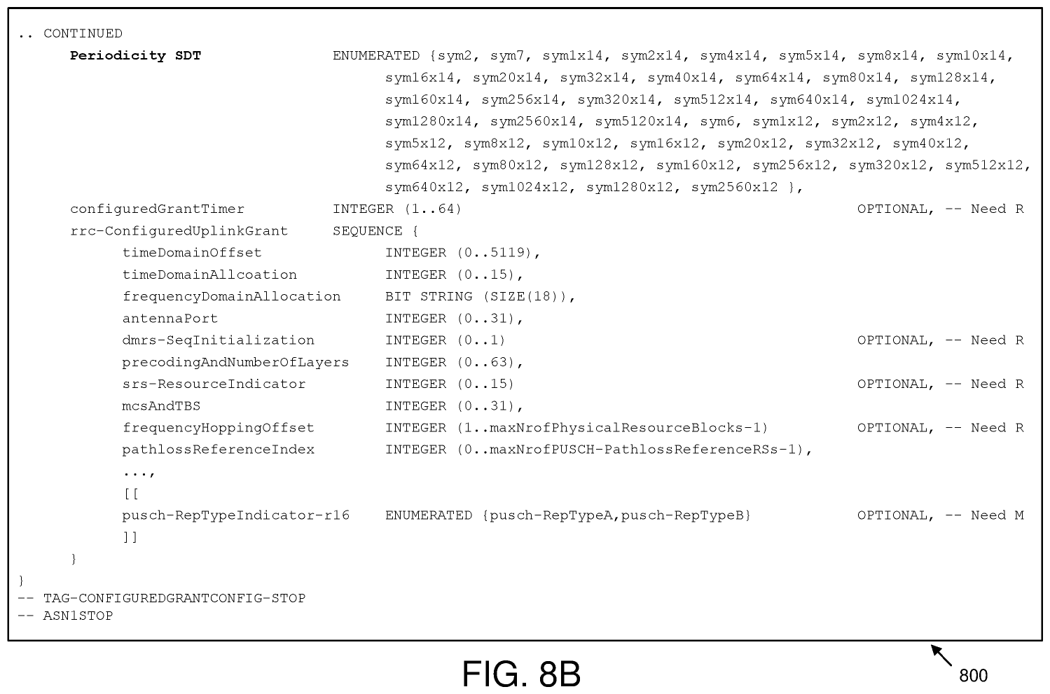

FIGS. 8A-8B depicts an ASN.1 representation 800 of an exemplary ConfiguredGrantConfig IE, according to embodiments of the disclosure. The depicted IE contains the new additional periodicity described above. The additional periodicity used for CG-SDT resources within a SDT session/procedure is denoted by the parameter “Periodicity_SDT” (see FIG. 8B), which indicates the CG-SDT resources within a SDT session, and corresponds to the second periodicity described above.

According to embodiments of a fifth solution, the UE 205 maintains a new timer per HARQ process which controls autonomous (re)transmissions of a TB having been transmitted on the associated HARQ process. According to one implementation of the fifth solution, the new timer is started or restarted at the transmission of a TB on a configured grant resource, i.e., CG PUSCH on a HARQ process. Note that the MAC entity includes a HARQ entity for each Serving Cell with configured uplink (including the case when it is configured with supplementary Uplink (“SUL”)), which maintains a number of parallel HARQ processes. As noted above, the timer is maintained per HARQ process.

In one specific implementation, the new timer associated with a HARQ process is started or restarted at the transmission of a TB on a CG-SDT resource on that HARQ process.

In one implementation, the timer of a HARQ process is stopped upon the reception of a PDCCH which is addressed to that HARQ process, e.g., PDCCH indicating a UL or DL transmission.

In one specific implementation, the timer of a HARQ process is stopped upon the reception of a PDCCH indicating a new initial UL or DL transmission for that HARQ process. Upon expiry of the timer associated with a HARQ process, the UE 205 performs some (autonomous) (re)transmission of the TB pending in the HARQ buffer. Autonomous (re)transmission refers to the case, where the UE 205 performs the transmission of the TB pending in the HARQ buffer without receiving some explicit network signaling indicating to perform the transmission of the TB.

According to some further aspect of the fifth solution, the UE 205 starts/restarts the new timer only for the initial uplink transmission of a SDT session, e.g., TB containing the RRCResumeRequest message. By starting the new timer only for the initial SDT transmission, it is ensured that the autonomous (re)transmission functionality is only supported for the initial SDT TB/message and is not supported for subsequent UL transmissions within a SDT session.

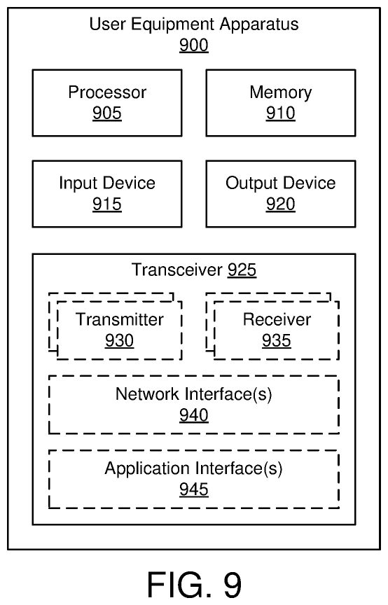

FIG. 9 depicts a user equipment apparatus 900 that may be used for SDT procedure using CG resources, according to embodiments of the disclosure. In various embodiments, the user equipment apparatus 900 is used to implement one or more of the solutions described above. The user equipment apparatus 900 may be one embodiment of a user endpoint, such as the remote unit 105 and/or the UE 205, as described above. Furthermore, the user equipment apparatus 900 may include a processor 905, a memory 910, an input device 915, an output device 920, and a transceiver 925.

In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. In some embodiments, the transceiver 925 communicates with one or more cells (or wireless coverage areas) supported by one or more base units 121. In various embodiments, the transceiver 925 is operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the user equipment apparatus 900 to implement the above-described UE behaviors. In certain embodiments, the processor 905 may include an application processor (also known as “main processor”) which manages application-domain and operating system (“OS”) functions and a baseband processor (also known as “baseband radio processor”) which manages radio functions.

In various embodiments, via the transceiver 925, the processor 905 receives, from a network entity (e.g., a gNB and/or RAN node) a configuration that allocates configured uplink grants for small data transmission. In some embodiments, to receive the configuration, the processor 905 causes the user equipment apparatus 900 to receive an RRC release message. In such embodiments, the RRC release message comprises the configuration that allocates configured uplink grants for small data transmission.

As used herein, the configured uplink grant (also referred to as “configured grant” or “CG”) refers to a semi-static (e.g., semi-persistent) allocation of uplink resources (e.g., CG Type-1 resources for small data transmission). As described above, the small data transmission may comprise an amount of user data that is smaller than the data volume threshold.

Via the transceiver 925, the processor 905 transmits, to the network entity, an initial configured grant small data transmission of a SDT procedure using a configured uplink grant for small data transmission. In some embodiments, the processor 905 causes the user equipment apparatus 900 to transmit the initial configured grant small data transmission while the apparatus is in an RRC inactive state (e.g., RRC_INACTIVE). In some embodiments, the initial configured grant small data transmission comprises a message of the CCCH logical channel. In certain embodiments, the initial configured grant small data transmission comprises an RRC resume request message.

The processor 905 suppresses (e.g., skips) processing a subsequent configured uplink grant allocated for small data transmission for an initial new transmission of subsequent uplink data of the SDT procedure. In some embodiments, the processor 905 suppresses processing the configured uplink grants allocated for small data transmission for the initial new transmission of the subsequent uplink data of the SDT procedure by causing the user equipment apparatus 900 to refrain from performing LCP procedure until the confirmation of the initial configured grant small data transmission is received.

In some embodiments, the processor 905 suppresses processing the configured uplink grants allocated for small data transmission for the initial new transmission of the subsequent uplink data of the SDT procedure by causing the user equipment apparatus 900 to consider as invalid a PUSCH allocation for new TBs until the confirmation of the initial configured grant small data transmission is received.

Via the transceiver 925, the processor 905 receives, from the network entity, confirmation of the initial configured grant small data transmission. In some embodiments, the confirmation of the initial configured grant small data transmission comprises a PDCCH transmission addressed to a C-RNTI of the user equipment apparatus 900. In one embodiment, the PDCCH transmission schedules an initial PDSCH transmission. In another embodiment, in response to the initial configured grant small data transmission comprising a buffer status report, the PDCCH transmission schedules an initial PUSCH transmission.

In response to receiving the confirmation of the initial configured grant small data transmission, the processor 905 process the subsequent configured uplink grant allocated for small data transmission for an initial new transmission of subsequent uplink data of the SDT procedure. In some embodiments, in response to receiving the confirmation of the initial configured grant small data transmission, the processor 905 further causes the user equipment apparatus 900 to: A) generate a TB for the subsequent uplink data of the SDT procedure and B) transmit the TB using the subsequent configured uplink grant allocated for small data transmission.

In some embodiments, the processor 905 causes the user equipment apparatus 900 to: A) maintain an autonomous retransmission timer for a HARQ process having a HARQ process ID; B) start a respective autonomous retransmission timer in response to the apparatus transmitting the initial configured grant small data transmission, where the initial configured grant small data transmission is associated with a respective HARQ process ID; and C) stop the respective autonomous retransmission timer in response to the apparatus receiving the confirmation of the initial configured grant small data transmission.

In some embodiments, in response to expiry of the respective autonomous retransmission timer prior to receiving the confirmation of the initial configured grant small data transmission, the processor 905 causes the user equipment apparatus 900 to perform autonomous retransmission of the initial configured grant small data transmission. In certain embodiments, the processor 905 causes the user equipment apparatus 900 to perform the retransmission for the initial configured grant SDT transmission with a same HARQ process (e.g., having the same HARQ process ID) on a following configured uplink grant allocated for small data transmission.

In some embodiments, the confirmation of the initial configured grant small data transmission comprises a PDCCH transmission addressed to the respective HARQ process. In certain embodiments, the PDCCH transmission schedules, for the respective HARQ process, an initial PDSCH transmission and/or an initial PUSCH transmission. In some embodiments, the processor 905 causes the user equipment apparatus 900 to start the respective autonomous retransmission timer only for the initial configured grant small data transmission and not for a subsequent transmission of the SDT procedure.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to SDT procedure using CG resources. For example, the memory 910 may store parameters, configurations, and the like as described above. In certain embodiments, the memory 910 also stores program code and related data, such as an operating system or other controller algorithms operating on the user equipment apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least one transmitter 930 and at least one receiver 935. One or more transmitters 930 may be used to provide UL communication signals to a base unit 121, such as the UL transmissions described herein. Similarly, one or more receivers 935 may be used to receive DL communication signals from the base unit 121, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one or more common control signals or as modular transmitters 930 and receivers 935 implemented in the same hardware chip or in a multi-chip module.

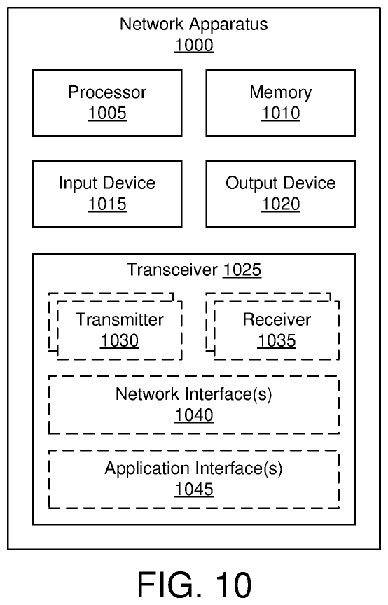

FIG. 10 depicts a network apparatus 1000 that may be used for SDT procedure using CG resources, according to embodiments of the disclosure. In one embodiment, the network apparatus 1000 may be one implementation of a network endpoint, such as the base unit 121 and/or RAN node 210, as described above. Furthermore, the network apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the network apparatus 1000 may not include any input device 1015 and/or output device 1020. In various embodiments, the network apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the network apparatus 1000 is a RAN node (e.g., gNB) that communicates with one or more UEs, as described herein. In such embodiments, the processor 1005 controls the network apparatus 1000 to perform the above-described RAN behaviors. When operating as a RAN node, the processor 1005 may include an application processor (also known as “main processor”) which manages application-domain and operating system (“OS”) functions and a baseband processor (also known as “baseband radio processor”) which manages radio functions.

In various embodiments, via the transceiver 1025, the processor 1005 transmits, to a UE, a configuration that allocates configured uplink grants for small data transmission and receives, from the UE, an initial configured grant small data transmission of a SDT procedure using a configured uplink grant for small data transmission. Via the transceiver 1025, the processor 1005 transmits, to the UE, confirmation for a reception of the initial configured grant small data transmission and, responsive to the confirmation, receives a TB for subsequent uplink data of the SDT procedure using a subsequent configured uplink grant allocated for small data transmission.

In some embodiments, the initial configured grant small data transmission is received while the communication device (e.g., UE) is in an RRC inactive state. In some embodiments, the initial configured grant small data transmission comprises a message of the CCCH logical channel. In certain embodiments, the initial configured grant small data transmission comprises a RRC resume request message.

In some embodiments, the confirmation of the initial configured grant small data transmission comprises a PDCCH transmission addressed to a C-RNTI of the apparatus. In certain embodiments, the PDCCH transmission schedules an initial PDSCH transmission. In another embodiment, in response to the initial configured grant small data transmission comprising a buffer status report, the PDCCH transmission schedules an initial PUSCH transmission.

In some embodiments, to transmit the configuration, the processor 1005 causes the transceiver 1025 to send a RRC release message, where the RRC release message comprises the configuration that allocates configured uplink grants for small data transmission. In some embodiments, the configuration further configures the UE for autonomous retransmission for a HARQ process having a HARQ process ID.

In certain embodiments, the initial configured grant small data transmission is associated with a respective HARQ process ID. In such embodiments, the confirmation of the initial configured grant small data transmission comprises a PDCCH transmission addressed to the respective HARQ process. In one embodiment, the PDCCH transmission schedules an initial PDSCH transmission for the respective HARQ process. In another embodiment, the PDCCH transmission schedules an initial PUSCH transmission for the respective HARQ process.

The memory 1010, in one embodiment, is a computer readable storage medium. In some embodiments, the memory 1010 includes volatile computer storage media. For example, the memory 1010 may include a RAM, including DRAM, SDRAM, and/or SRAM. In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to SDT procedure using CG resources. For example, the memory 1010 may store parameters, configurations, and the like, as described above. In certain embodiments, the memory 1010 also stores program code and related data, such as an operating system or other controller algorithms operating on the network apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 includes at least one transmitter 1030 and at least one receiver 1035. One or more transmitters 1030 may be used to communicate with the UE, as described herein. Similarly, one or more receivers 1035 may be used to communicate with network functions in the PLMN and/or RAN, as described herein. Although only one transmitter 1030 and one receiver 1035 are illustrated, the network apparatus 1000 may have any suitable number of transmitters 1030 and receivers 1035. Further, the transmitter(s) 1030 and the receiver(s) 1035 may be any suitable type of transmitters and receivers.

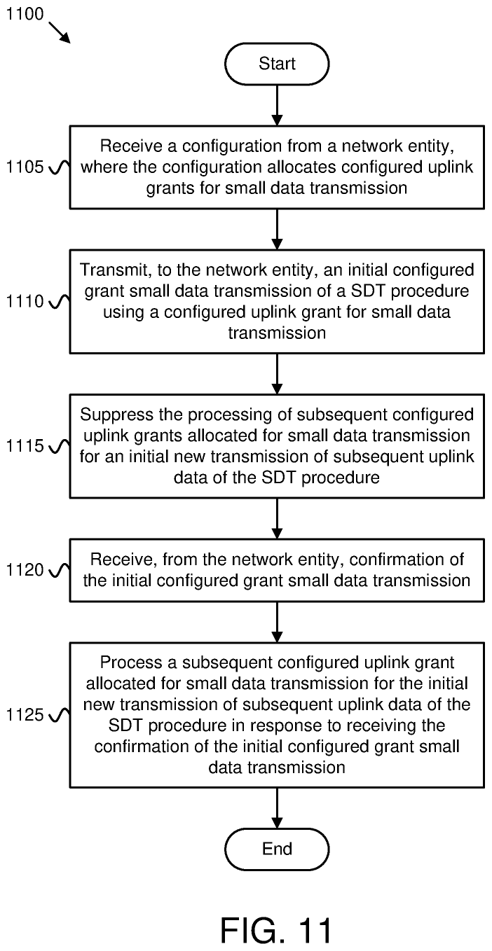

FIG. 11 depicts one embodiment of a method 1100 for SDT procedure using CG resources, according to embodiments of the disclosure. In various embodiments, the method 1100 is performed by a communication device, such as a remote unit 105, a UE 205, and/or the user equipment apparatus 900, as described above. In some embodiments, the method 1100 is performed by a processor, such as a microcontroller, a microprocessor, a CPU, a GPU, an auxiliary processing unit, a FPGA, or the like.

The method 1100 includes receiving 1105, from a network entity (e.g., a gNB and/or RAN node), a configuration that allocates configured uplink grants for small data transmission. The method 1100 includes transmitting 1110, to the network entity, an initial configured grant small data transmission of a SDT procedure using a configured uplink grant for small data transmission. The method 1100 includes suppressing 1115 the processing of subsequent configured uplink grants allocated for small data transmission for an initial new transmission of subsequent uplink data of the SDT procedure. The method 1100 includes receiving 1120, from the network entity, confirmation of the initial configured grant small data transmission. The method 1100 includes processing 1125 a subsequent configured uplink grant allocated for small data transmission for the initial new transmission of subsequent uplink data of the SDT procedure in response to receiving the confirmation of the initial configured grant small data transmission.

Disclosed herein is a first apparatus for SDT procedure using CG resources, according to embodiments of the disclosure. The first apparatus may be implemented by a communication device, such as a remote unit 105, a UE 205, and/or the user equipment apparatus 900, as described above. The first apparatus includes a processor coupled to a memory, the processor configured to cause the apparatus to: A) receive, from a network entity (e.g., a gNB and/or RAN node) a configuration that allocates configured uplink grants for small data transmission; B) transmit, to the network entity, an initial configured grant small data transmission of a SDT procedure using a configured uplink grant for small data transmission; C) suppress processing a subsequent configured uplink grant allocated for small data transmission for an initial new transmission of subsequent uplink data of the SDT procedure; D) receive, from the network entity, confirmation of the initial configured grant small data transmission; and E) process the subsequent configured uplink grant allocated for small data transmission for an initial new transmission of subsequent uplink data of the SDT procedure in response to receiving the confirmation of the initial configured grant small data transmission.

In some embodiments, the processor is further configured to cause the apparatus to: A) generate a TB for the subsequent uplink data of the SDT procedure and B) transmit the TB using the subsequent configured uplink grant allocated for small data transmission. In some embodiments, the processor is configured to cause the apparatus to transmit the initial configured grant small data transmission while the apparatus is in an RRC inactive state (e.g., RRC_INACTIVE).

In some embodiments, the initial configured grant small data transmission comprises a CCCH message. In certain embodiments, the initial configured grant small data transmission comprises an RRC resume request message.

In some embodiments, the confirmation of the initial configured grant small data transmission comprises a PDCCH transmission addressed to a C-RNTI of the apparatus. In one embodiment, the PDCCH transmission schedules an initial PDSCH transmission. In another embodiment, in response to the initial configured grant small data transmission comprising a buffer status report, the PDCCH transmission schedules an initial PUSCH transmission.

In some embodiments, to receive the configuration, the processor is configured to cause the apparatus to receive an RRC release message. In such embodiments, the RRC release message comprises the configuration that allocates configured uplink grants for small data transmission.

In some embodiments, to suppress processing the configured uplink grants allocated for small data transmission for the initial new transmission of the subsequent uplink data of the SDT procedure, the processor is configured to cause the apparatus to refrain from performing LCP procedure until the confirmation of the initial configured grant small data transmission is received.

In some embodiments, to suppress processing the configured uplink grants allocated for small data transmission for the initial new transmission of the subsequent uplink data of the SDT procedure, the processor is configured to cause the apparatus to consider as invalid a PUSCH allocation for new TBs until the confirmation of the initial configured grant small data transmission is received.

In some embodiments, the processor is configured to cause the apparatus to: A) maintain an autonomous retransmission timer for a HARQ process having a HARQ process ID; B) start a respective autonomous retransmission timer in response to the apparatus transmitting the initial configured grant small data transmission, where the initial configured grant small data transmission is associated with a respective HARQ process ID; and C) stop the respective autonomous retransmission timer in response to the apparatus receiving the confirmation of the initial configured grant small data transmission.

In some embodiments, in response to expiry of the respective autonomous retransmission timer prior to receiving the confirmation of the initial configured grant small data transmission, the processor is configured to cause the apparatus to perform autonomous retransmission of the initial configured grant small data transmission. In certain embodiments, the processor is configured to cause the apparatus to perform the retransmission for the initial configured grant SDT transmission with a same HARQ process (e.g., having the same HARQ process ID) on a following configured uplink grant allocated for small data transmission.

In some embodiments, the confirmation of the initial configured grant small data transmission comprises a PDCCH transmission addressed to the respective HARQ process. In certain embodiments, the PDCCH transmission schedules, for the respective HARQ process, an initial PDSCH transmission and/or an initial PUSCH transmission. In some embodiments, the processor is configured to cause the apparatus to start the respective autonomous retransmission timer only for the initial configured grant small data transmission and not for a subsequent transmission of the SDT procedure.

Disclosed herein is a first method for SDT procedure using CG resources, according to embodiments of the disclosure. The first method may be performed by a communication device, such as a remote unit 105, a UE 205, and/or the user equipment apparatus 900, as described above. The first method includes receiving, from a network entity (e.g., a gNB and/or RAN node), a configuration that allocates configured uplink grants for small data transmission and transmitting, to the network entity, an initial configured grant small data transmission of a Small Data Transmission (“SDT”) procedure using a configured uplink grant for small data transmission. The first method includes suppressing the processing of subsequent configured uplink grants allocated for small data transmission for an initial new transmission of subsequent uplink data of the SDT procedure. The first method includes receiving, from the network entity, confirmation of the initial configured grant small data transmission and processing a subsequent configured uplink grant allocated for small data transmission for the initial new transmission of subsequent uplink data of the SDT procedure in response to receiving the confirmation of the initial configured grant small data transmission.

In some embodiments, the first method further comprises generating a TB for the subsequent uplink data of the SDT procedure and transmitting the TB using the subsequent configured uplink grant allocated for small data transmission. In some embodiments, the initial configured grant small data transmission is transmitted while the communication device (e.g., UE) is in an RRC inactive state.

In some embodiments, the initial configured grant small data transmission comprises a CCCH message. In certain embodiments, the initial configured grant small data transmission comprises a RRC resume request message.

In some embodiments, the confirmation of the initial configured grant small data transmission comprises a PDCCH transmission addressed to a C-RNTI of the apparatus. In certain embodiments, the PDCCH transmission schedules an initial PDSCH transmission. In another embodiment, in response to the initial configured grant small data transmission comprising a buffer status report, the PDCCH transmission schedules an initial PUSCH transmission.

In some embodiments, receiving the configuration comprises receiving a RRC release message, where the RRC release message comprises the configuration that allocates configured uplink grants for small data transmission.

In some embodiments, suppressing the processing of configured uplink grants allocated for small data transmission for the initial new transmission of the subsequent uplink data of the SDT procedure comprises refraining from performing LCP procedure until the confirmation of the initial configured grant small data transmission is received.

In some embodiments, suppressing the processing of configured uplink grants allocated for small data transmission for the initial new transmission of the subsequent uplink data of the SDT procedure comprises considering as invalid a PUSCH allocation for new TBs until the confirmation of the initial configured grant small data transmission is received.

In some embodiments, the first method further includes: maintain an autonomous retransmission timer for a HARQ process having a HARQ process ID; starting a respective autonomous retransmission timer in response to the apparatus transmitting the initial configured grant small data transmission, where the initial configured grant small data transmission is associated with a respective HARQ process ID; and stopping the respective autonomous retransmission timer in response to the apparatus receiving the confirmation of the initial configured grant small data transmission.

In some embodiments, in response to expiry of the respective autonomous retransmission timer prior to receiving the confirmation of the initial configured grant small data transmission, the first method further includes performing autonomous retransmission of the initial configured grant small data transmission. In certain embodiments, the retransmission is performed for the initial configured grant SDT transmission with a same HARQ process (e.g., having the same HARQ process ID) on a following configured uplink grant allocated for small data transmission.

In some embodiments, the confirmation of the initial configured grant small data transmission comprises a PDCCH transmission addressed to the respective HARQ process. In one embodiment, the PDCCH transmission schedules an initial PDSCH transmission for the respective HARQ process. In another embodiment, the PDCCH transmission schedules an initial PUSCH transmission for the respective HARQ process. In some embodiments, the respective autonomous retransmission timer is started only for the initial configured grant small data transmission and not for a subsequent transmission of the SDT procedure.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a configuration that allocates resources using configured uplink grants for small data transmission (SDT);
transmit an initial data transmission of a SDT procedure using a configured uplink grant for SDT;
suppress processing of a subsequent configured uplink grant allocated for SDT, wherein the subsequent configured uplink grant is associated with an initial new transmission of subsequent uplink data of the SDT procedure;
receive a confirmation of the initial data transmission; and
process the subsequent configured uplink grant in response to the received confirmation of the initial data transmission.

2. The UE of claim 1, wherein the at least one processor is further configured to cause the UE to:
generate a transport block (TB) for the subsequent uplink data of the SDT procedure; and
transmit the TB using the subsequent configured uplink grant allocated for SDT.

3. The UE of claim 1, wherein the initial data transmission comprises a common control channel (CCCH) message.

4. The UE of claim 3, wherein the initial data transmission comprises a radio resource control (RRC) resume request message.

5. The UE of claim 1, wherein the confirmation of the initial data transmission comprises a physical downlink control channel (PDCCH) transmission addressed to a cell-specific radio temporary network identifier (C-RNTI) of the UE.

6. The UE of claim 5, wherein the PDCCH transmission schedules an initial physical downlink shared channel (PDSCH) transmission or schedules an initial physical uplink shared channel (PUSCH) transmission.

7. The UE of claim 1, wherein the at least one processor is configured to cause the UE to transmit the initial data transmission while the UE is in a radio resource control (RRC) inactive state.

8. The UE of claim 1, wherein to receive the configuration, the at least one processor is configured to cause the UE to receive a radio resource control (RRC) release message, the RRC release message comprising the configuration.

9. The UE of claim 1, wherein to suppress processing the configured uplink grants allocated for SDT for the initial new transmission of the subsequent uplink data of the SDT procedure, the at least one processor is configured to cause the UE to refrain from performing logical channel prioritization (LCP) procedure until the confirmation of the initial data transmission is received.

10. The UE of claim 1, wherein to suppress processing the configured uplink grants allocated for SDT for the initial new transmission of the subsequent uplink data of the SDT procedure, the at least one processor is configured to cause the UE to consider as invalid a physical uplink shared channel (PUSCH) allocation for new TBs until the confirmation of the initial data transmission is received.

11. The UE of claim 1, wherein the at least one processor is configured to cause the UE to:
maintain an autonomous retransmission timer for a hybrid automatic repeat request (HARQ) process having a HARQ process identifier (ID);
start a respective autonomous retransmission timer in response to the initial data transmission, wherein the initial data transmission is associated with a respective HARQ process ID; and
stop the respective autonomous retransmission timer in response to the confirmation of the initial data transmission.

12. The UE of claim 11, wherein the at least one processor is configured to cause the UE to perform autonomous retransmission of the initial data transmission in response to expiry of the respective autonomous retransmission timer prior to receiving the confirmation of the initial data transmission.

13. The UE of claim 12, wherein the at least one processor is configured to cause the UE to perform the retransmission for the initial data transmission with a same HARQ process on a following configured uplink grant allocated for SDT.

14. The UE of claim 11, wherein the at least one processor is configured to cause the UE to start the respective autonomous retransmission timer only for the initial data transmission and not for a subsequent transmission of the SDT procedure.

15. A method of a User Equipment (UE), the method comprising:
receiving a configuration that allocates resources using configured uplink grants for small data transmission (SDT);
transmitting an initial data transmission of a SDT procedure using a configured uplink grant for SDT;
suppressing processing of a subsequent configured uplink grant allocated for SDT, wherein the subsequent configured uplink grant is associated with an initial new transmission of subsequent uplink data of the SDT procedure;
receiving a confirmation of the initial data transmission; and
processing the subsequent configured uplink grant in response to the received confirmation of the initial data transmission.

16. The method of claim 15, further comprising:
generating a transport block (TB) for the subsequent uplink data of the SDT procedure; and
transmitting the TB using the subsequent configured uplink grant allocated for SDT.

17. The method of claim 15, wherein the initial data transmission comprises a common control channel (CCCH) message.

18. The method of claim 15, wherein the confirmation of the initial data transmission comprises a physical downlink control channel (PDCCH) transmission addressed to a cell-specific radio temporary network identifier (C-RNTI).

19. A base station for wireless communication, comprising:
at least one memory; and
at least one processor coupled with the at least one memory and configured to cause the base station to:
transmit a configuration that allocates resources using configured uplink grants for small data transmission (SDT);
receive an initial data transmission of a SDT procedure using a configured uplink grant for SDT, wherein a subsequent configured uplink grant allocated for SDT is suppressed, wherein the subsequent configured uplink grant is associated with an initial new transmission of subsequent uplink data of the SDT procedure; and
transmit a confirmation of the initial data transmission, wherein the subsequent configured uplink grant is processed in response to the transmitted confirmation of the initial data transmission.

20. A method performed by a base station, the method comprising:
transmitting a configuration that allocates resources using configured uplink grants for small data transmission (SDT);
receiving an initial data transmission of a SDT procedure using a configured uplink grant for SDT, wherein a subsequent configured uplink grant allocated for SDT is suppressed, wherein the subsequent configured uplink grant is associated with an initial new transmission of subsequent uplink data of the SDT procedure; and
transmitting a confirmation of the initial data transmission, wherein the subsequent configured uplink grant is processed in response to the transmitted confirmation of the initial data transmission.
